(19) United States
(12) Patent Application Publication
(10) Pub. No.: US 2020/0199328 A1
(43) Pub. Date: Jun. 25, 2020

(54) POLYESTER COMPOSITION WITH GAS BARRIER PROPERTIES

(71) Applicant: Far Eastern New Century Corporation, Taipei (TW)

(72) Inventors: Li-Ling Chang, TAIPEI (TW); Kuan-Liang Wei, TAIPEI (TW); Chuan-Hao Hsu, TAIPEI (TW); Yih-Wei Wu, TAIPEI (TW)

(21) Appl. No.: 16/395,159

(22) Filed: Apr. 25, 2019

(30) Foreign Application Priority Data
Dec. 22, 2018 (TW) 107146651

(51) Int. Cl. C08K 5/12; C08K 5/52; C08K 5/00

(52) U.S. Cl. CPC C08K 5/12; C08K 5/005; C08K 5/52

(57) ABSTRACT

A polyester composition with gas barrier properties, including polyester polymerized by glycol and dicarboxylic acid, gas barrier enhancing additives, and antioxidants, wherein the gas barrier enhancing additive includes compounds with following chemical formula:

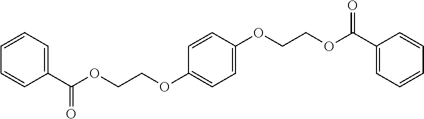 [SMILES: O=C(OCCOc1ccc(OCCOC(=O)c2ccccc2)cc1)c1ccccc1]

### BACKGROUND OF THE INVENTION

### 1. Field of the Invention

The present invention relates generally to a polyester composition, and more specifically, to a polyester composition with enhanced gas barrier property.

### 2. Description of the Prior Art

Polyethylene terephthalate (PET) and the copolyester thereof are widely used in plastic bottles for various carbonated beverages, tea drinks or the applications needed to prevent gas permeation from the bottle. However, in the case that the sales territories of the beverage bottle are in remote islands or the case more delivery time is needed, the shelf life of PET bottle should be extended to meet the use-by day of the packaged beverage. On the other hand, current beverage bottle has a developing trend toward lightweight bottle design. The gas barrier effect of plastic bottle is inevitably reduced in this lightweight process. Accordingly, the design of current beverage bottle may not meet such requirements.

In order to meet the aforementioned requirement, some approaches are adopted in current conventional skill. One of the approaches, like the one disclosed in U.S. Patent Pub No. 2010/0234501, is by adding small molecule gas barrier additives to improve the gas barrier ability of the bottle. However, gas barrier additive with small molecules is prone to react with PET in transesterification, which may further degrade the PET in chain scission degradation and deteriorate the mechanical property of PET bottle. Another approach, like the one disclosed in U.S. Pat. No. 8,545,952, is by adding chain extender in addition to the gas barrier additive to maintain the mechanical property of PET. However, the process of this approach is unstable in long-time production and the bottle is likely to suffer bottle speckle issue. In addition, some organic small molecules used in this approach are not well compatible with PET structure, so as to increase the haze and lower the transparency of bottle product.

### SUMMARY OF THE INVENTION

In order to meet the requirements of a beverage bottle and solve possible problems in prior art as mentioned above, the present invention provides a polyester composition with enhanced gas barrier property. With gas barrier enhancing additive having larger molecular weight, it is less likely for the PET material to degrade in elevated temperatures, and the additive is compatible with the PET structure to maintain the high transparency of bottle. The additional antioxidant not only prevents the PET degradation and improves the gas barrier property, but also lessens the yellowing degree of the bottle.

One objective of the present invention is to provide a polyester composition with gas barrier property, which is consisted of polyester polymerized by glycol and dicarboxylic acid, gas barrier enhancing additives and antioxidants, wherein the gas barrier enhancing additive includes compounds with following chemical formula:

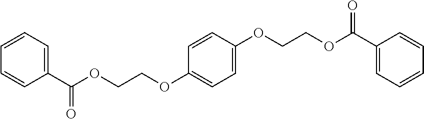 [SMILES: O=C(OCCOc1ccc(OCCOC(=O)c2ccccc2)cc1)c1ccccc1]

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

none

### DETAILED DESCRIPTION

The present invention provides a polyester composition with gas barrier property, including polyester made of glycol and dicarboxylic acid through polycondensation reaction, wherein the glycol may be selected from the group comprising ethylene glycol, 1,2-propanediol, 1,3-propanediol, diethylene glycol, 2,2-dimethyl-1,3-propanediol, 1,3-butanediol, 1,4-butanediol, 1,5-pentanediol, 1,6-hexanediol, 2,2,4-trimethyl-1,6-hexanediol, 1,3-cyclohexanedimethanol, or 1,4-cyclohexanedimethanol, and the dicarboxylic acid may be selected from the group comprising terephthalic acid, isophthalic acid, 2,6-naphthalic acid, 1,5-naphthalic acid, or a combination thereof.

Treat a total weight of the polyester as 100 parts of weight, the polyester composition of the present invention is added with gas barrier enhancing additive in an amount from 0.01 to 10 parts by weight, preferably from 1.0 to 5.0 parts by weight. The gas barrier enhancing additive may be prepared through the following methods: (1) prepared through a reaction of hydroquinone bis(2-hydroxyethyl) ether and benzoic acid; (2) prepared through a reaction of hydroquinone bis(2-hydroxyethyl) ether and methyl benzoate; (3) prepared by first preparing hydroquinone bis(2-hydroxyethyl) ether through a reaction of hydroquinone and ethylene carbonate, and then react the hydroquinone bis(2-hydroxyethyl) ether with benzoic acid; (4) prepared by first preparing hydroquinone bis(2-hydroxyethyl) ether through a reaction of hydroquinone and ethylene carbonate, and then react the hydroquinone bis(2-hydroxyethyl) ether with methyl benzoate; (5) prepared by first preparing hydroquinone bis(2-hydroxyethyl) ether through a reaction of hydroquinone and ethylene oxide, and then react the hydroquinone bis(2-hydroxyethyl) ether with benzoic acid; (6) prepared by first preparing hydroquinone bis(2-hydroxyethyl) ether through a reaction of hydroquinone and ethylene oxide, and then react the hydroquinone bis(2-hydroxyethyl) ether with methyl benzoate.

All aforementioned methods can, but not limited, prepare the gas barrier enhancing additive claimed by the present invention as the following formula (I):

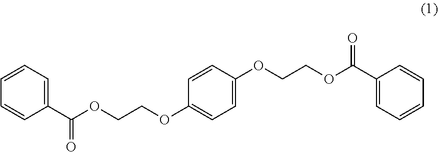 [SMILES: O=C(OCCOc1ccc(OCCOC(=O)c2ccccc2)cc1)c1ccccc1]

In order to facilitate the description of following embodiments, the gas barrier enhancing additive is referred to hereinafter as PB02.

Take the aforementioned synthesis method (2) as example. Put a 490 g (about 2.47 mole) hydroquinone bis(2-hydroxyethyl) ether and a 297 g (about 2.18 mole) methyl benzoate in a 1 liter glass reactor. Set the temperature at 120° C. and stir the reactor simultaneously to dissolve the reactants completely and remove unnecessary vapor. Heat the reactor to 190° C. and use a fractionation device to fractionate the methanol produced in the reaction. Use thin layer chromatography to monitor if the reaction is completed. Thereafter, heat the crude product to 70° C. and dissolve it in a 2409 ml tetrahydrofuran solvent. Let the solution stand still at room temperature 25° C. for about 12 hours to crystalize, and then use 500 ml ethyl acetate to separate the PB02 product from the solution, with a weight about 804 g, purity larger than 99% and yield about 80%.

Furthermore, treat a total weight of the polyester as 100 parts of weight, the polyester composition of the present invention will be further added with antioxidants in an amount from 0.1 to 1 parts by weight, preferably from 0.3 to 0.6 parts by weight. The antioxidant includes hindered phenol series, such as primary antioxidant products like CHINOX® 1010, CHINOX® 245, CHINOX® 3114, or phosphite series such as secondary antioxidant product like CHINOX® 168, CHINOX® 618, CHINOX® 626, or a combination of the two aforementioned antioxidant series, such as CHINOX® 850, CHINOX® B215, CHINOX® B225, all supplied by Double Bond Chemical Ind., Co., (Taiwan) Ltd.

In addition, depending on process requirement or applied fields, the polyester composition of the present invention may be further added with a moderate amount of additives, such as colorant, antistatic agent, flame retardant, UV-stabilizer, antiskid agent, plasticizer, inorganic filler or lubricant. Treat a total weight of the polyester as 100 parts of weight, these additional additives are preferably in an amount of 0-30 parts by weight.

The polyester compositions of the present invention are all made by mixing powdery polyethylene terephthalate, gas barrier enhancing additive and antioxidant to produce plastic preform in conventional injection molding condition. The plastic preform is further made into a plastic bottle in conventional blow molding condition. The polyester composition material may be made into various products by using different processing methods, depending on its follow-up application.

### Embodiment

The experimental group and control group below will use following chemicals:
1. Polyethylene terephthalate (PET) granules, product model CB608, purchased from Far Eastern New Century Corporation, Taiwan.
2. Gas barrier enhancing additive synthesized through aforementioned method, with hydroquinone bis(2-hydroxyethyl) ether and methyl benzoate materials both purchased from Acros Organics.
3. Antioxidants CHINOX® 168 and CHINOX® 618 , both purchased from Double Bond Chemical Ind., Co., (Taiwan) Ltd, with following chemical formulas (II), (III) respectively:

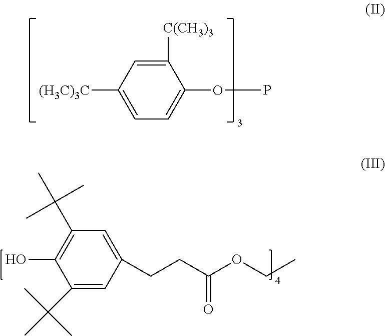

4. Glyceryl tribenzoate (referred hereinafter as GT), purchased from SIGMA-ALDRICH, with following chemical formulas (IV):

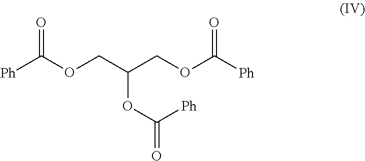 [SMILES: O=C(OCC(COC(=O)c1ccccc1)OC(=O)c1ccccc1)c1ccccc1]

5. Pentaerythritol tetrabenzoate (referred hereinafter as PT), purchased from SIGMA-ALDRICH, with following chemical formulas (V):

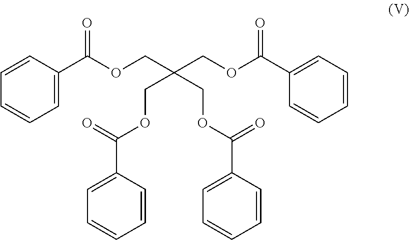 [SMILES: O=C(OCC(COC(=O)c1ccccc1)(COC(=O)c1ccccc1)COC(=O)c1ccccc1)c1ccccc1]

### Instrument Measurement

1. Identify the structure of PB02 and analyze the purity of PB02: using nuclear magnetic resonance spectrometer (Bruker, 400 MHz, CDCL₃).
2. Intrinsic viscosity (dl/g): use ASTM D4603 instrument to measure.
3. Haze: use ASTM D1003 instrument to measure.
4. CO₂ shelf life: use 10.8675 g sodium bicarbonate and 10.02 g citric acid with 600 ml deionized water in a 630 ml carbonated beverage bottle. Screw the cap immediately and place the sample standing in a room at 25° C. for 3 days. Thereafter, use PERMATRAN-C Model 10 instrument (MOCON, Inc) to measure the time required for CO₂ loss in the bottle to be smaller than 17.5%. This time is the CO₂ shelf life.
5. Oxygen transmission rate (OTR): use ASTM D3985 instrument to measure.
6. Chroma (L/a/b): use colorimeter (Hunter Associates Laboratory, Inc) to measure.

### Experimental Group I

Grind 100 parts by weight PET granules into powder and place them into an oven at 140° C., drying for 12 hours. The powder is dried until the moisture content is 50 ppm, and then mix the powder completely with 3.0 parts by weight gas barrier enhancing additive PB02 and 0.1 parts by weight antioxidant CHINOX® 1010. Thereafter, the completely mixed powder is put into a preform injection molding machine and is injection molded at 270° C. to obtain a 29 g thick preform. The preform is then put into blow molding machine and is blow molded at 90° C. to form a 630 ml carbonated beverage bottle.

### Experimental Group II

Same as EXPERIMENTAL GROUP I, except the addition level of CHINOX® 1010 is changed to 0.3 parts by weight.

### Experimental Group III

Same as EXPERIMENTAL GROUP I, except the antioxidant is changed to CHINOX® 168.

### Experimental Group IV

Same as EXPERIMENTAL GROUP III, except the addition level of CHINOX® 168 is changed to 0.3 parts by weight.

### Control Group I

Grind PET granules into powder and place them into an oven at 140° C., drying for 12 hours. The powder is dried until the moisture content is 50 ppm. The dried powder is put into a preform injection molding machine and is injection molded at 270° C. to obtain a 29 g thick preform. The preform is then put into blow molding machine and is blow molded at 90° C. to form a 630 ml carbonated beverage bottle.

### Control Group II

Grind 100 parts by weight PET granules into powder and place them into an oven at 140° C., drying for 12 hours. The powder is dried until the moisture content is 50 ppm, and then mix the powder completely with 1.0 parts by weight gas barrier enhancing additive PB02. Thereafter, the completely mixed powder is put into a preform injection molding machine and is injection molded at 270° C. to obtain a 29 g thick preform. The preform is then put into blow molding machine and is blow molded at 90° C. to form a 630 ml carbonated beverage bottle.

### Control Group III

Same as CONTROL GROUP II, except the addition level of the gas barrier enhancing additive PB02 is changed to 3.0 parts by weight.

### Control Group IV

Same as CONTROL GROUP II, except the addition level of the gas barrier enhancing additive PB02 is changed to 5.0 parts by weight.

### Control Group V

Grind 100 parts by weight PET granules into powder and place them into an oven at 140° C., drying for 12 hours. The powder is dried until the moisture content is 50 ppm, and then mix the powder completely with 3.0 parts by weight gas barrier enhancing additive PB02 and 0.025 parts by weight conventional chain extender (pyromellitic dianhydride, PMDA). Thereafter, the completely mixed powder is put into a preform injection molding machine and is injection molded at 270° C. to obtain a 29 g thick preform. The preform is then put into blow molding machine and is blow molded at 90° C. to form a 630 ml carbonated beverage bottle.

### Control Group VI

Same as CONTROL GROUP V, except the addition level of the PMDA is changed to 0.075 parts by weight.

The aforementioned experimental groups and control groups are all measured by aforementioned instruments to obtain their properties of intrinsic viscosity (IV), chroma (L/a/b), haze, oxygen transmission rate (OTR), CO₂ shelf life, and bottle speckle. The result is shown in following TABLE I:

TABLE I

| | | gas | | | | | | | |
|---|---|---|---|---|---|---|---|---|---|
| | | barrier | | | | | | | |
| | | enhancing | | | | | | | |
| | | additive | additives | | | | | CO₂ | |
| | PET | PB02 | and amount | | | | OTR | shelf | |
| | (parts by | (parts by | (parts by | IV | chroma | haze | (cc/ | life | bottle |
| | weight) | weight) | weight) | (dl/g) | (L/a/b) | (%) | pkg-day) | (days) | speckle |
| EXPERIMENTAL | 100 | 3 | 0.1 | 0.70 | 94.0/−0.3/2.1 | 1.99 | 0.032 | 108 | N |
| GROUP I | | | CHINOX | | | | | | |
| | | | 1010 | | | | | | |
| EXPERIMENTAL | 100 | 3 | 0.3 | 0.74 | 93.5/−1.0/3.3 | 2.03 | 0.026 | 112 | N |
| GROUP II | | | CHINOX | | | | | | |
| | | | 1010 | | | | | | |
| EXPERIMENTAL | 100 | 3 | 0.1 | 0.70 | 95.0/−0.2/1.0 | 2.00 | 0.030 | 109 | N |
| GROUP III | | | CHINOX | | | | | | |
| | | | 168 | | | | | | |
| EXPERIMENTAL | 100 | 3 | 0.3 | 0.73 | 95.5/−0.3/0.7 | 1.99 | 0.024 | 114 | N |
| GROUP IV | | | CHINOX | | | | | | |
| | | | 168 | | | | | | |
| CONTROL | 100 | 0 | 0 | 0.73 | 94.9/0.0/0.7 | 1.88 | 0.051 | 70 | N |
| GROUP I | | | | | | | | | |
| CONTROL | 100 | 1 | 0 | 0.71 | 95.0/−0.1/0.9 | 1.78 | 0.044 | 75 | N |
| GROUP II | | | | | | | | | |
| CONTROL | 100 | 3 | 0 | 0.68 | 94.8/−0.1/1.1 | 2.01 | 0.034 | 104 | N |
| GROUP III | | | | | | | | | |
| CONTROL | 100 | 5 | 0 | 0.68 | 93.2/−0.1/2.3 | 3.45 | 0.030 | 108 | N |
| GROUP IV | | | | | | | | | |
| CONTROL | 100 | 3 | 0.025 | 0.70 | 94.6/−0.3/1.0 | 1.92 | 0.031 | 106 | a few |
| GROUP V | | | PMDA | | | | | | |
| CONTROL | 100 | 3 | 0.075 | 0.74 | 95.0/−0.2/1.5 | 2.03 | 0.029 | 110 | Y |
| GROUP VI | | | PMDA | | | | | | |

As it can be seen from the experiment result in TABLE I above, in the groups with gas barrier enhancing additive PB02 such as control group I to control group IV, the oxygen transmission rate (OTR) gradually decreases (from 0.051 to 0.030 cc/pkg-day) as the amount of the gas barrier enhancing additive increases (0 parts by weight to 5 parts by weight). This result reflects that the gas barrier enhancing additive PB02 can indeed improve the gas barrier property of the bottle, with the haze increased from 1.88% to 3.45% instead. However, the intrinsic viscosity is also decreased in the result from 0.73 dl/g to 0.68 dl/g. The mechanical property of the preforms is accordingly deteriorated so that they cannot withstand the positive pressure during blow molding and the product yield is therefore declined. To be used in business application, the intrinsic viscosity should be maintained at a level not lower than 0.70 and the haze at a level not higher than 2.2%, and at the same time, the oxygen transmission rate is maintained at a level not higher than 0.04 cc/pkg-day and the CO₂ shelf life at a level not lower than 100 days.

Accordingly, as shown in the result of experiment group I to experiment group IV in comparison to the control group III, it can be seen from the TABLE I that the intrinsic viscosity is significantly improved (from 0.68 dl/g to 0.74 dl/g) with the addition of antioxidants CHINOX® 1010 or CHINOX® 168. The higher the addition level of antioxidant, the better the intrinsic viscosity improved. Furthermore, as shown in the result of experiment group I and experiment group II in comparison to the result of experiment group III and experiment group IV, increase the addition level of antioxidant may also further improves the gas barrier property of the bottle (OTR increased from 0.032 to 0.026 cc/pkg-day). This result reflects the addition of the antioxidant can improve both the mechanical property and gas barrier property of the bottle. The aforementioned experiment group I to experiment group IV and control group I to control group IV all show no bottle speckle issue, and the bottle appearance shows no obvious yellowing issue.

On the other hand, as shown in the experiment result of control group V and control group VI, although the addition of conventional PMDA chain extender may improve the gas barrier property (OTR increased from 0.034 to 0.029 cc/pkg-day) and the intrinsic viscosity (from 0.68 dl/g to 0.74 dl/g) of the bottle, it is also prone to form bottle speckles. Obvious speckles would start to appear when the addition level is higher than 0.075 parts by weight. These speckles make the bottle look like having some foreign body. The result reflects that the approach of adding chain extender in conventional skill is likely to suffer bottle speckle issue.

In order to compare the difference between the gas barrier enhancing additive PB02 of the present invention and other gas barrier enhancing additives, control group VII and control group VIII are added as follows:

### Control Group VII

Grind 100 parts by weight PET granules into powder and place them into an oven at 140° C., drying for 12 hours. The powder is dried until the moisture content is 50 ppm. Thereafter, mix the powder completely with 3.0 parts by weight conventional gas barrier enhancing additive GT (glyceryl tribenzoate, referred to the aforementioned chemicals description). The completely mixed powder is then put into a preform injection molding machine and is injection molded at 270° C. to obtain a 29 g thick preform. The preform is then put into blow molding machine and is blow molded at 90° C. to form a 630 ml carbonated beverage bottle.

### Control Group VIII

Grind 100 parts by weight PET granules into powder and place them into an oven at 140° C., drying for 12 hours. The powder is dried until the moisture content is 50 ppm, and then mix the powder completely with 3.0 parts by weight gas barrier enhancing additive PT (pentaerythritol tetrabenzoate, referred to the aforementioned chemicals description). Thereafter, the completely mixed powder is put into a preform injection molding machine and is injection molded at 270° C. to obtain a 29 g thick preform. The preform is then put into blow molding machine and is blow molded at 90° C. to form a 630 ml carbonated beverage bottle.

The control groups added above are measured by aforementioned instruments to obtain their properties of intrinsic viscosity (IV), chroma (L/a/b), haze, oxygen transmission rate (OTR), CO₂ shelf life, and bottle speckle. The measurement result is compared to the ones of aforementioned control group I (without any gas barrier enhancing additive) and control group III (with gas barrier enhancing additive PB02 of the present invention) as shown in following TABLE II:

TABLE II

| | | gas | | | | | | | |
|---|---|---|---|---|---|---|---|---|---|
| | | barrier | | | | | | | |
| | | enhancing | additives | | | | | CO₂ | |
| | PET | additive | and amount | | | | OTR | shelf | |
| | (parts by | (parts by | (parts by | IV | chroma | haze | (cc/ | life | bottle |
| | weight) | weight) | weight) | (dl/g) | (L/a/b) | (%) | pkg-day) | (days) | speckle |
| CONTROL | 100 | 0 | 0 | 0.73 | 94.9/0.0/0.7 | 1.88 | 0.051 | 70 | N |
| GROUP I | | | | | | | | | |
| CONTROL | 100 | 3 | 0 | 0.68 | 94.8/−0.1/1.1 | 2.01 | 0.034 | 104 | N |
| GROUP III | | (PB02) | | | | | | | |
| CONTROL | 100 | 3 | 0 | 0.66 | 95.0/−0.2/1.3 | 1.98 | 0.054 | 70 | N |
| GROUP VII | | (GT) | | | | | | | |
| CONTROL | 100 | 3 | 0 | 0.67 | 95.2/−0.3/1.5 | 2.01 | 0.056 | 69 | N |
| GROUP VIII | | (PT) | | | | | | | |

The gas barrier enhancing additive PB02 of the present invention, the gas barrier enhancing additive GT (glyceryl tribenzoate) and gas barrier enhancing additive PT (pentaerythritol tetrabenzoate) all belong to the derivatives of benzoate. It can be seen from TABLE II above that the gas barrier performances (OTR) of Group VII (with GT) and Group VIII (with PT) and the control group I (without any gas barrier enhancing additive) are very close. This result reflects that the additives GT and PT can hardly improve the gas barrier performance of PET. In comparison thereto, the present invention uses different benzoate derivative as gas barrier enhancing additive, and it appears to have significant improvement to the gas barrier performance for PET material.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A polyester composition with gas barrier properties, comprising:
polyester polymerized by glycol and dicarboxylic acid;
gas barrier enhancing additive, wherein said gas barrier enhancing additive has compounds with following chemical formula: 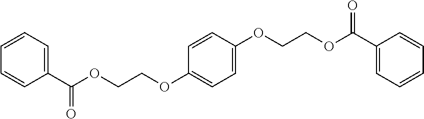 [SMILES: O=C(OCCOc1ccc(OCCOC(=O)c2ccccc2)cc1)c1ccccc1]
and;
antioxidant.

2. The polyester composition with gas barrier properties of claim 1, wherein said gas barrier enhancing additive is presented in an amount from 0.01 to 10 parts by weight based on 100 parts by weight of said polyester.

3. The polyester composition with gas barrier properties of claim 1, wherein said gas barrier enhancing additive is presented in an amount from 1 to 5 parts by weight based on 100 parts by weight of said polyester.

4. The polyester composition with gas barrier properties of claim 1, wherein said antioxidant is presented in an amount from 0.1 to 1 parts by weight based on 100 parts by weight of said polyester.

5. The polyester composition with gas barrier properties of claim 1, wherein said antioxidant is presented in an amount from 0.3 to 0.6 parts by weight based on 100 parts by weight of said polyester.

6. The polyester composition with gas barrier properties of claim 1, wherein said glycol is selected from the group comprising ethylene glycol, 1,2-propanediol, 1,3-propanediol, diethylene glycol, 2,2-dimethyl-1,3-propanediol, 1,3-butanediol, 1,4-butanediol, 1,5-pentanediol, 1,6-hexanediol, 2,2,4-trimethyl-1,6-hexanediol, 1,3-cyclohexanedimethanol, or 1,4-cyclohexanedimethanol.

7. The polyester composition with gas barrier properties of claim 1, wherein said dicarboxylic acid is selected from the group comprising terephthalic acid, isophthalic acid, 2,6-naphthalic acid, or 1,5-naphthalic acid.

8. The polyester composition with gas barrier properties of claim 1, wherein said polyester is polyethylene terephthalate.

9. The polyester composition with gas barrier properties of claim 1, wherein said antioxidant is selected from the group comprising hindered phenol, sub-phosphate ester, or a combination thereof.
